(19) United States
(12) Patent Application Publication
(10) Pub. No.: US 2024/0098538 A1
(43) Pub. Date: Mar. 21, 2024

(54) RRM MEASUREMENT ACTIVITY REPORTING AND USAGE

(71) Applicant: Nokia Technologies Oy, Espoo (FI)

(72) Inventors: Jussi-Pekka KOSKINEN, Oulu (FI); Timo KOSKELA, Oulu (FI); Jorma Johannes KAIKKONEN, Oulu (FI); Samuli Heikki TURTINEN, Oulu (FI)

(21) Appl. No.: 18/262,500

(22) PCT Filed: Jan. 28, 2022
(86) PCT No.: PCT/US2022/014191

§ 371 Date: Jul. 21, 2023

Related U.S. Application Data
(60) Provisional application No. 63/143,104, filed on Jan. 29, 2021.

(51) Int. Cl. H04W 24/10; H04L 5/00

(52) U.S. Cl. CPC H04W 24/10; H04L 5/0053

(57) ABSTRACT

At a user equipment in a connected mode with a wireless network, transmitting by the user equipment measurement activity information to the wireless network. The user equipment performs measurements. At a network node having configured user equipment to a connected mode, configuring, by the network node, the user equipment to report measurement activity information to the network node. The network node receives the measurement activity information from the user equipment.

### TECHNICAL FIELD

Exemplary embodiments herein relate generally to wireless networks and, more specifically, relate to Radio Resource Management (RRM) activity reporting and usage such as RRM measurements, RRM measurement activity reporting, utilization of measurement gap, and scheduling in wireless networks.

### BACKGROUND

Abbreviations that may be found in the specification and/or the drawing figures are defined below, at the end of the detailed description section.

In a wireless network such as a cellular network, User Equipment (UEs) connect to the network via base stations. Recently, low cost, power efficient UEs with reduced capability (REDCAP UEs) have been introduced, and standardization is ongoing, for non-eMBB (non-enhanced Mobile Broadband) use cases, such as Internet of Things (IoT) devices, wearables, sensors, and the like. These REDCAP UEs typically have low complexity and compact form factor, and may also be stationary or move within a relatively small space (e.g., a forklift in a warehouse). As such, REDCAP UEs may have less mobility than other UEs. The REDCAP UEs may also have smaller batteries too, which means that power saving is important, although for any UE, power savings is important.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 is an illustration of the MeasGapConfig (measurement gap configuration) and GapConfig (gap configuration) IEs;

FIG. 2A is a table of the field descriptions in FIG. 2;

FIG. 2B is a table of gap pattern configurations;

FIG. 3 is a logic flow and signaling diagram for radio resource management relaxation reporting and scheduling, in accordance with an exemplary embodiment;

FIG. 4 is a logic flow and signaling diagram for radio resource measurement activity information reporting and scheduling for a first alternative example building on FIG. 3;

FIG. 5 is a logic flow and signaling diagram for measurement activity information reporting and scheduling for a second alternative example building on FIG. 3;

FIG. 6 is a logic flow diagram performed by a user equipment for measurement activity reporting and usage, in accordance with an exemplary embodiment; and

FIG. 7 is a logic flow diagram performed by a network node for measurement activity reporting and usage, in accordance with an exemplary embodiment.

### BRIEF SUMMARY

This section is intended to include examples and is not intended to be limiting.

In an exemplary embodiment, a method is disclosed that includes, at a user equipment in a connected mode with a wireless network, transmitting by the user equipment measurement activity information to the wireless network. The method also includes performing, by the user equipment, measurements.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus at least to: at a user equipment in a connected mode with a wireless network, transmit by the user equipment measurement activity information to the wireless network; and perform, by the user equipment, measurements.

An exemplary computer program product includes a computer-readable storage medium bearing computer program code embodied therein for use with a computer. The computer program code includes: code, at a user equipment in a connected mode with a wireless network, for transmitting by the user equipment measurement activity information to the wireless network; and code for performing, by the user equipment, measurements.

In another exemplary embodiment, an apparatus comprises means for performing: at a user equipment in a connected mode with a wireless network, transmitting by the user equipment measurement activity information to the wireless network; and performing, by the user equipment, measurements.

In an exemplary embodiment, a method is disclosed that includes at a network node having configured user equipment to a connected mode, configuring, by the network node, the user equipment to report measurement activity information to the network node. The method includes receiving by the network node the measurement activity information from the user equipment.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus at least to: at a network node having configured user equipment to a connected mode, configuring, by the network node, the user equipment to report measurement activity information to the network node; and receiving by the network node the measurement activity information from the user equipment.

An exemplary computer program product includes a computer-readable storage medium bearing computer program code embodied therein for use with a computer. The computer program code includes: code, at a network node having configured user equipment to a connected mode, for configuring, by the network node, the user equipment to report measurement activity information to the network node; and code for receiving by the network node the measurement activity information from the user equipment.

In another exemplary embodiment, an apparatus comprises means for performing: at a network node having configured user equipment to a connected mode, configuring, by the network node, the user equipment to report measurement activity information to the network node; and receiving by the network node the measurement activity information from the user equipment.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “1”, and in general as used within this description, the “I” may be interpreted as “or”, “and”, or “both”.

The exemplary embodiments herein describe techniques for RRM relaxation reporting and scheduling. Additional description of these techniques is presented after a system into which the exemplary embodiments may be used is described.

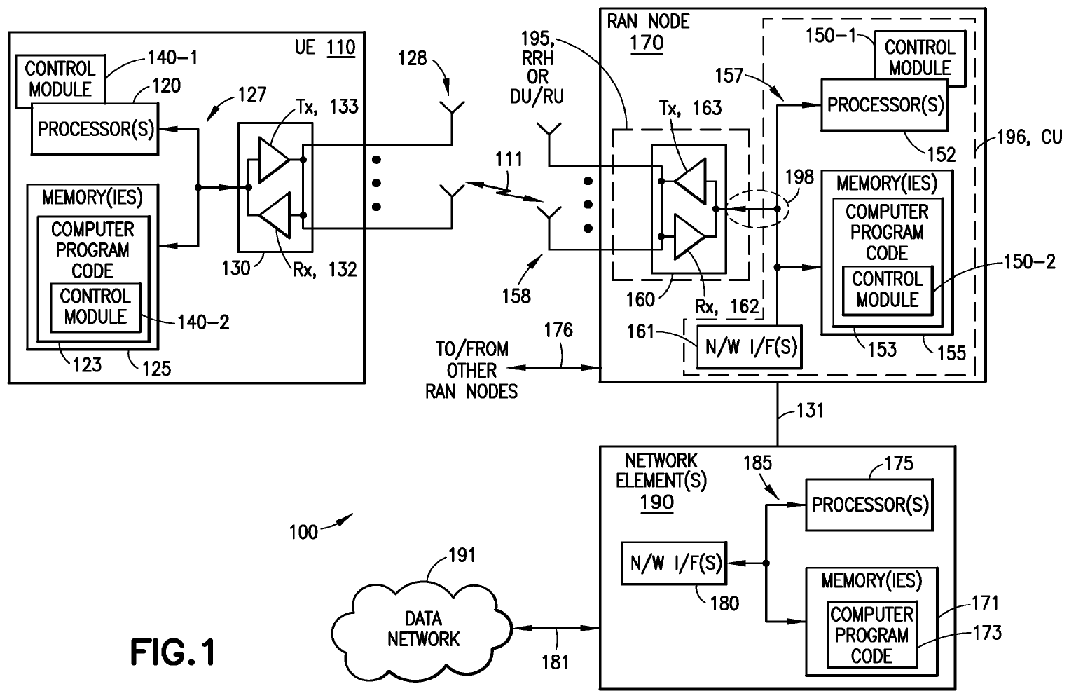

Turning to FIG. 1, this figure shows a block diagram of one possible and non-limiting exemplary system in which the exemplary embodiments may be practiced. A user equipment (UE) 110, radio access network (RAN) node 170, and network element(s) 190 are illustrated. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a control module 140, comprising one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 is a base station that provides access by wireless devices such as the UE 110 to the wireless network 100. The RAN node 170 may be, for instance, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (e.g., the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by one gNB-DU. The gNB-DU terminates the F1 interface 198 connected with the gNB-CU. Note that the DU 195 is considered to include the transceiver 160, e.g., as part of an RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a control module 150, comprising one of or both parts 150-1 and/or 150-2, which may be implemented in a number of ways. The control module 150 may be implemented in hardware as control module 150-1, such as being implemented as part of the one or more processors 152. The control module 150-1 may be implemented also as an integrated circuit or through other hardware such as a programmable gate array. In another example, the control module 150 may be implemented as control module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the control module 150 may be distributed, such as being distributed between the DU 195 and the CU 196, or be implemented solely in the DU 195.

The one or more network interfaces 161 communicate over a network such as via the links 176 and 131. Two or more RAN nodes 170 communicate using, e.g., link 176. The link 176 may be wired or wireless or both and may implement, e.g., an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, e.g., fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that the base station that forms the cell will perform the functions. The cell makes up part of a base station. That is, there can be multiple cells per base station. For instance, there could be three cells for a single carrier frequency and associated bandwidth, each cell covering one-third of a 360-degree area so that the single base station's coverage area covers an approximate oval or circle. Furthermore, each cell can correspond to a single carrier and a base station may use multiple carriers. So, if there are three 120-degree cells per carrier and two carriers, then the base station has a total of 6 cells.

The wireless network 100 may include a network element or elements 190 that may include core network functionality, and which provides connectivity via a link or links 181 with a data network 191, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor-based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general-purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, vehicles with a modem device for wireless V2X (vehicle-to-everything) communication, image capture devices such as digital cameras having wireless communication capabilities, gaming devices having wireless communication capabilities, music storage and playback appliances having wireless communication capabilities, Internet appliances (including Internet of Things, IoT, devices) permitting wireless Internet access and possibly browsing, IoT devices with sensors and/or actuators for automation applications with wireless communication tablets with wireless communication capabilities, as well as portable units or terminals that incorporate combinations of such functions.

Having thus introduced one suitable but non-limiting technical context for the practice of the exemplary embodiments, the exemplary embodiments will now be described with greater specificity.

The exemplary embodiments herein relate to the RRM relaxations intended for, e.g., stationary devices, both in IDLE/Inactive and Connected modes. An overview of related technical areas is provided, then an introduction to the exemplary embodiments is provided.

As an overview, one reference in this technical area is Ericsson, New SID on support of reduced capability NR devices, RP-193238, 3GPP TSG RAN Meeting #86, Sitges, Spain, Dec. 9th-12, 2019. This reference states objectives of SI or core part WI or Testing part WI include the following:

Study UE power saving and battery lifetime enhancement for reduced capability UEs in applicable use cases (e.g., delay tolerant) [RAN2, RAN1]:
Reduced PDCCH monitoring by smaller numbers of blind decodes and CCE limits [RAN1].
Extended DRX for RRC Inactive and/or Idle [RAN2].
RRM relaxation for stationary devices [RAN2].

This was discussed in RAN2 #112e with the following agreements:
1. The RRM relaxation of REDCAP UEs is triggered based on measurements, as a baseline. Other triggering conditions for the “level-1” (still device at fixed location) UEs are not excluded, e.g., the possibility to signal their stationary property explicitly.
2. R16 NR RRM relaxation procedures are taken as a baseline to study further enhancements of neighbor cells RRM relaxation for REDCAP UEs in RRC IDLE/INACTIVE.
3. Relaxation of neighbor cells RRM measurements in RRC_CONNECTED will be studied in this SI/WI.

In REL-15, the UE may choose not to perform measurements if S-measures are met as per 3GPP TS 38.304:
Intra-frequency meas. can be omitted if serving cell fulfils:
   Srxlev>SIntraSearchP and Squal>SIntraSearchQ
Inter-frequency/RAT measurements
Higher priority: always measure according to requirements
Same/lower priority layers measurements can be omitted if serving cell fulfils:
   Srxlev>SnonIntraSearchP and Squal>SnonIntraSearchQ
Otherwise, the UE shall perform the measurements as indicated in SIB.

In REL-16, power saving in RRC_IDLE and RRC_INACTIVE can also be achieved by the UE relaxing RRM measurements of neighbor cells when the UE meets the criteria determining the UE is in low mobility and/or is not at a cell edge. The UE has to monitor whether the serving cell (e.g., using RSRP/RSRQ) fulfils any configured relaxation triggering criterion, defined in 3GPP TS 38.304, according to the configured thresholds as illustrated in part below.

Low-mobility if: (SrxlevRef−Srxlev)<SSearchDeltaP within TSearchDeltaP

where:
Srxlev: current Srxlev (RSRP) value of the serving cell
SrxlevRef: serving cell reference value set as Srxlev:
After (re-)selecting a new cell
If (SrxlevRef— Srxlev)>0
If criterion has not been met for TSearchDeltaP

Note: RAN4 has not defined accuracy requirements for idle mode measurements in general

Not-at-cell-edge trigger criterion

Not-at-cell-edge if: Srxlev>SSearchThresholdP and Squal>SSearchThresholdQ if SSearchThresholdQ is configured

where:

Srxlev=current Srxlev value of the serving cell (dB).
Squal=current Squal value of the serving cell (dB).

In Rel-15, for C-DRX operation in RRC Connected mode, the UE is provided configuration to enable discontinuous PDCCH monitoring as described in 3GPP TS 38.321 Section 5.7. In Rel-16, a Wake-up-Signal (WUS) or DCP (DCI Format Scrambled with PS-RNTI)) was introduced for NR to indicate whether a UE is required to start a drx-OnDurationTimer, i.e., if the UE receives a wake-up indication in the WUS occasions preceding the drx-OnDuration, the UE is required to be on active time and monitor PDCCH. In case the WUS does not indicate the UE to wake up/start the timer (e.g., the NW has no DL data/or other control to be transmitted in the next OnDuration for the given UE), the UE can skip the PDCCH monitoring during DRX-OnDuration for achieving power saving.

It would be beneficial to take into account the UE's relaxation level (described above) for the scheduling purposes, because the UE cannot be scheduled during the measurement gap. Otherwise, the UE 110 may be configured with a non-optimal measurement gap from the UL/DL scheduling perspective, resulting in wasted system capacity.

Currently, the measurement gap is configured based on the UE capability as described in 3GPP TS 38.300:

Whether a measurement is non-gap-assisted or gap-assisted depends on the capability of the UE, the active BWP of the UE and the current operating frequency:
For SSB based inter-frequency measurement, if the measurement gap requirement information is reported by the UE, a measurement gap configuration may be provided according to the information. Otherwise, a measurement gap configuration is always provided in the following cases:
If the UE only supports per-UE measurement gaps;
If the UE supports per-FR measurement gaps and any of the serving cells are in the same frequency range of the measurement object.
For SSB based intra-frequency measurement, if the measurement gap requirement information is reported by the UE, a measurement gap configuration may be provided according to the information. Otherwise, a measurement gap configuration is always provided in the following case:
Other than the initial BWP, if any of the UE configured BWPs do not contain the frequency domain resources of the SSB associated to the initial DL BWP.

In non-gap-assisted scenarios, the UE is able to carry out such measurements without measurement gaps. In gap-assisted scenarios, the UE cannot be assumed to be able to carry out such measurements without measurement gaps.

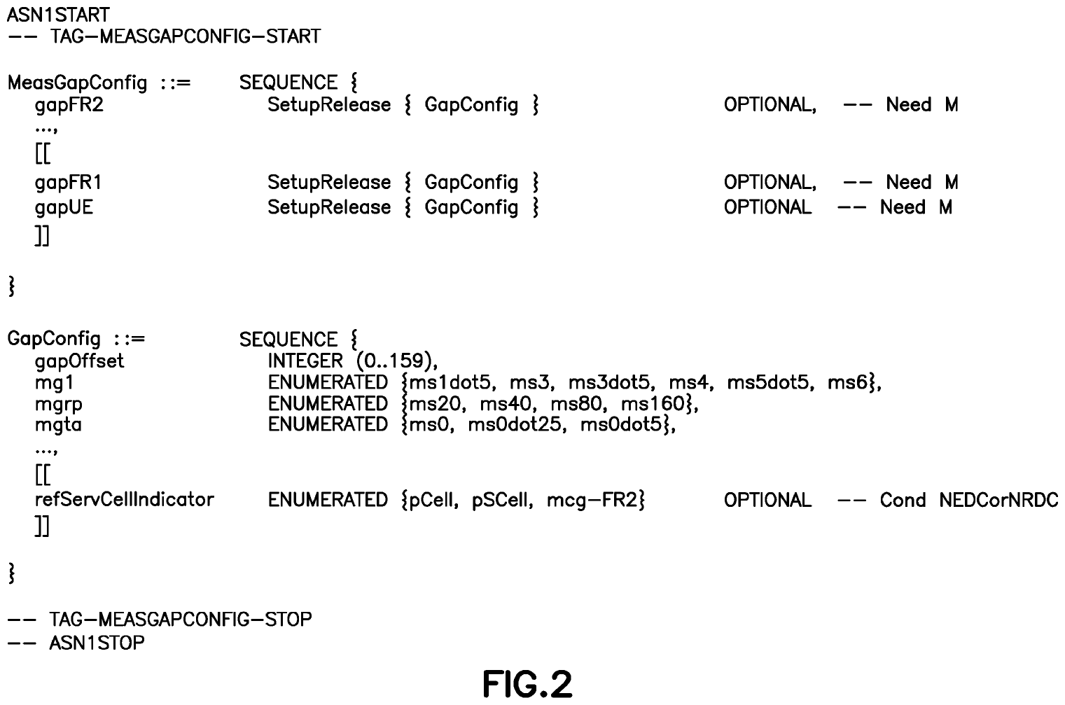

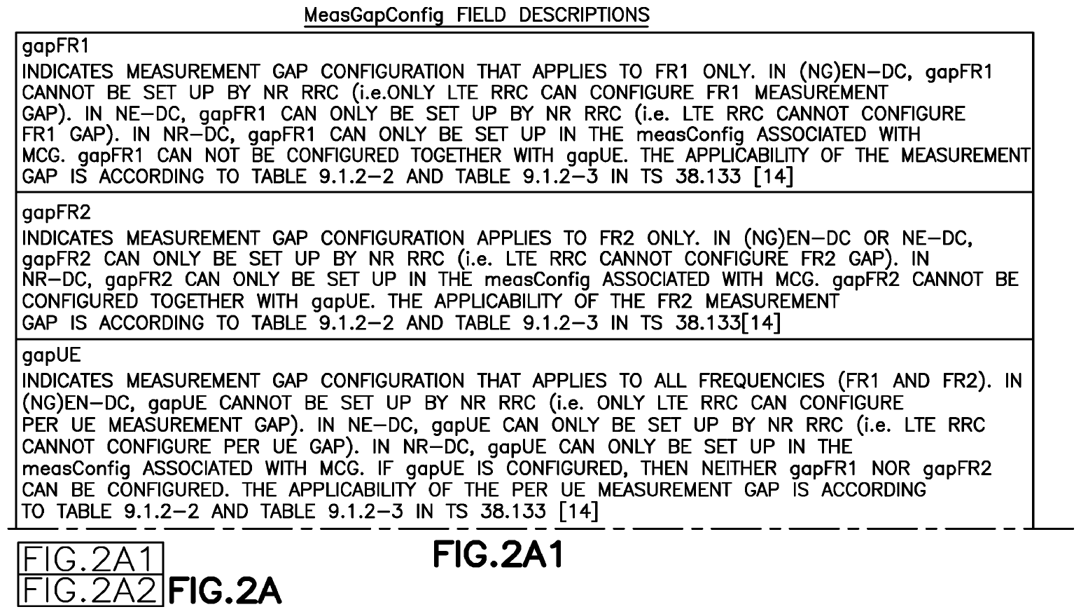

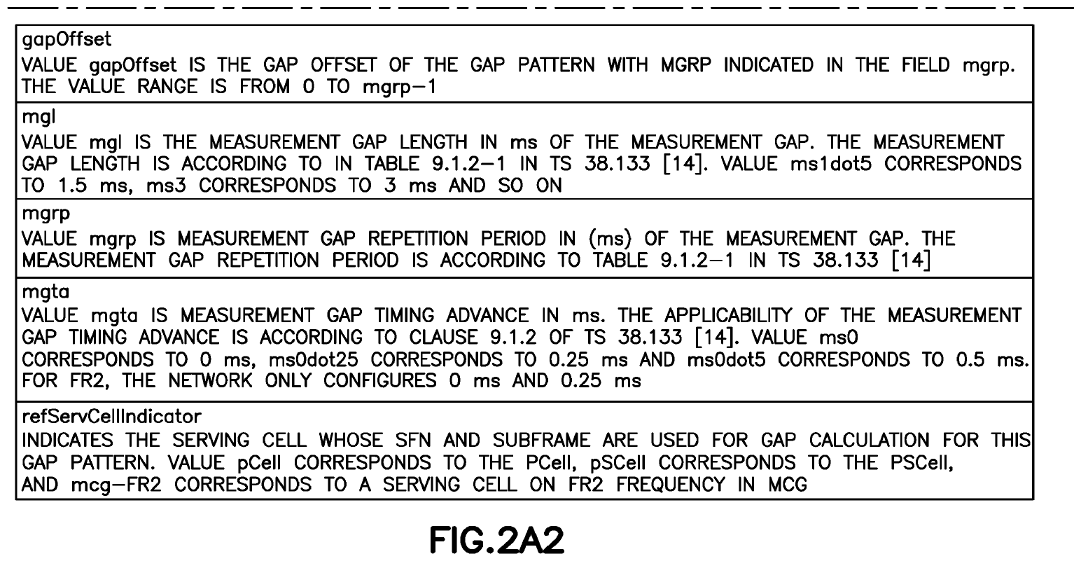

The measurement gap configuration is described in 3GPP TS 38.331 in Section 5.5.2.9. See, e.g., 3GPP TS 38.331 V15.12.0 (2020-12). In short, a UE is provided, by a MeasGapConfig IE, with a gapFR1 and/or a gapFR2 and/or gapUE, to set up GapConfig. The IE GapConfig provides the gapOffset to determine the timing location (offset), period and length of the measurement gap. See FIG. 2, which illustrates the IEs MeasGapConfig and GapConfig, and see FIG. 2A, which is a table of the field descriptions in FIG. 2.

The allowed gap pattern configurations (combinations of Measurement Gap Length (MGL, in ms) and Measurement Gap Repetition Period (MGRP, in ms) are listed in 3GPP TS 38.133 (Table 9.1.2-1: Gap Pattern Configurations). See 3GPP TS 38.133 V16.6.0 (2020-12), and FIG. 2B, which is a table of gap pattern configurations (Table 9.1.2-1, from 3GPP TS 38.133).

Now that an overview of related technical areas has been provided, an introduction to the exemplary embodiments is provided, and then additional details are provided.

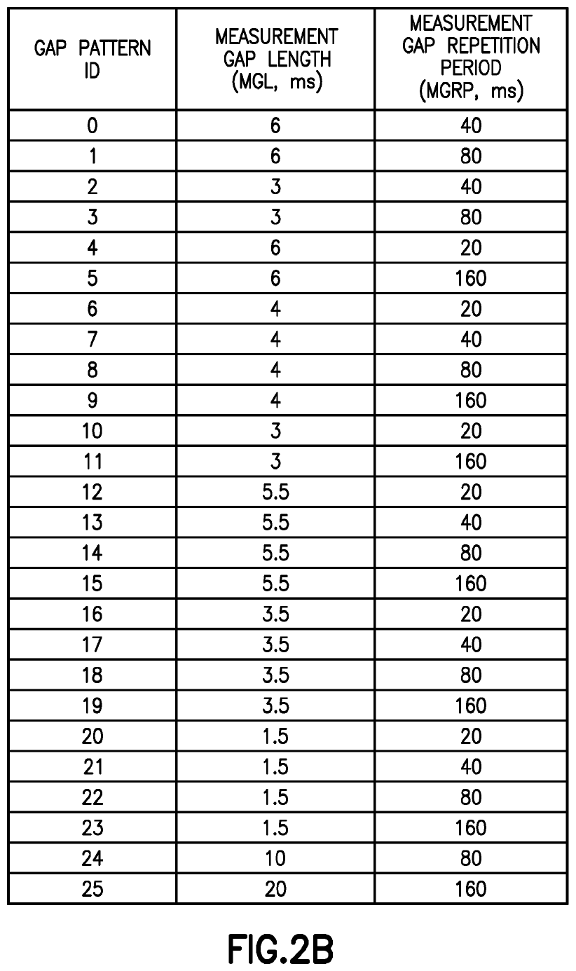

As an introduction, turn to FIG. 3, which is a logic flow and signaling diagram for radio resource management relaxation reporting and scheduling. This figure illustrates the operation of an exemplary method, a result of execution of computer program instructions embodied on a computer readable memory, functions performed by logic implemented in hardware, and/or interconnected means for performing functions in accordance with AN exemplary embodiment. The blocks in FIG. 3 are performed by a UE 110 or a network (NW) node 310, controlled by their respective control modules 140 or 150. The NW node 310 is an element in network 100, and may be a RAN node 170 or some element in the RAN node 170, such an RRH or a DU/RU (see reference 196 in FIG. 1).

In block 320, the UE 110 and NW node 310 align radio resource measurement relaxation state in order that the UE 110 and the network understand at least which measurement gap occasions are considered valid for radio resource management measurements (e.g., and valid measurement gap occasions are not used for data transmission/reception). The measurement gap is a time period that is reserved for measurements and during which the UE cannot (or is not mandated to) receive/transmit data from/to serving cell(s) during this time period, because the UE is performing measurements elsewhere, e.g., in non-serving cells. A measurement gap occasion is a time period set aside (e.g., known) to be a measurement gap. The NW node 310, in block 325, schedules and makes data transmissions/receptions accordingly (when a measurement gap is not ongoing) based at least on the aligned radio resource measurement relaxation state. In block 330, the UE 110 receives and/or transmits data according to scheduling and uses measurement gaps (if any) for RRM measurements according to the alignment with network in block 320. Scheduling of communications between UEs 110 and network nodes is well known.

The UE 110, in block 340, reports results of the radio resource measurements to the NW node 310. The NW node 310 receives reporting of results of radio resource measurements made by the UE 110 according to the aligned radio resource measurement relaxation state. See block 350. The NW node 310, in block 360, may perform one or more actions based on the received reporting. Exemplary actions are described below.

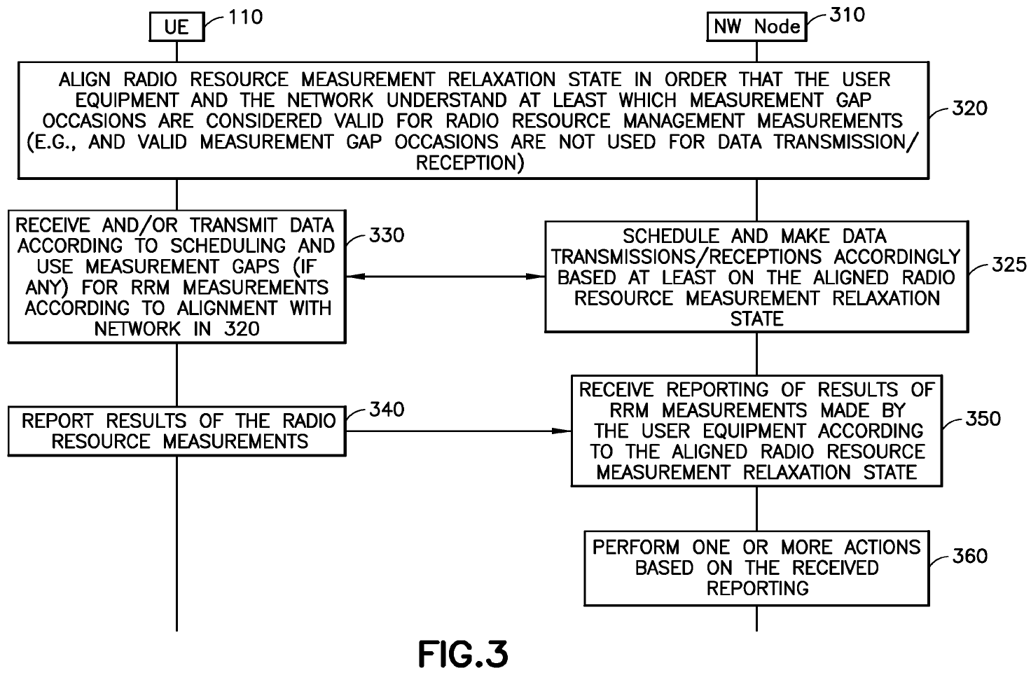

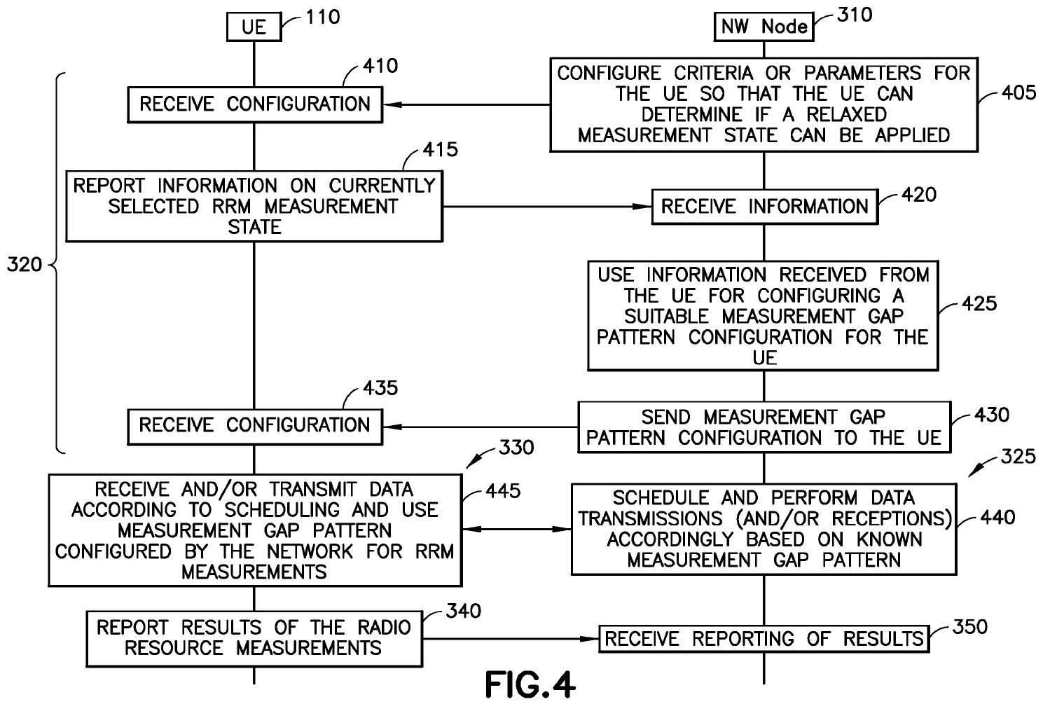

While FIG. 3 illustrates one main set of operations and corresponding signaling to implement an exemplary embodiment, two additional main alternatives are described below. In a first alternative (see FIG. 4), the UE 110 is basically configured via the alignment by the network 100, whereas in the second alternative (see FIG. 5), the UE 110 determines, during the alignment process, measurement gap configuration to be used.

Turning to FIG. 4, FIG. 4 is a logic flow and signaling diagram for radio resource measurement activity information reporting and scheduling for a first alternative example building on FIG. 3. FIG. 4 also illustrates the operation of an exemplary method, a result of execution of computer program instructions embodied on a computer readable memory, functions performed by logic implemented in hardware, and/or interconnected means for performing functions in accordance with an exemplary embodiment. The blocks in FIG. 4 are performed by the UE 110 or NW node 310, controlled by their respective control modules 140 or 150.

In this example, the alignment of the resource management state of block 320 from FIG. 3 is marked as being made of multiple blocks 405-435. Additionally, examples of blocks 330, 325, 340, and 350 are shown.

In block 405, the NW node 310 configures criteria or parameters for the UE 110 so that the UE 110 can determine if a relaxed measurement state can be applied. The UE 110 receives the configuration in block 410. In response, the UE 110 reports information on its currently selected RRM measurement state in block 415, which the NW node 310 receives in block 420.

In more general terms, the reported information can include one or more indications of radio resource control measurement relaxation level, or radio link monitoring measurement level, or low mobility condition information (e.g., whether the condition is fulfilled or not), or not-at-cell-edge condition information (e.g., whether this condition is fulfilled or not), or whether a threshold (e.g., a cell quality threshold or a beam quality threshold) for controlling whether the UE is required to perform measurements on non-serving cells is fulfilled or not, or selected measurement gap configuration, or the UE is not able or allowed to relax the measurements anymore, or UE's preferred measurement gap configuration. The preferred measurement gap configuration may comprise one or more of the following: gap for FR1/FR2; UE specific gap which applies to all frequencies; gap offset; gap length; gap repetition period; or gap timing advance.

The RRM measurement relaxation level may comprise indication of one or more of the following: no RRM measurements or relaxed RRM measurements or regular RRM measurements or relaxed RLM measurements or regular RLM measurements.

The threshold can include cell quality or one or more sets of ssb-RSRP used to derive a cell quality level (e.g., RSRP based on SS/PBCH block(s) measurement) or one or more of csi-RSRP corresponding to the cell level RSRP based on CSI-RS(s) measurement.

In block 425, the NW node 310 uses the information received from the UE 110 for configuring a suitable measurement gap pattern configuration for the UE. The NW node 310 in block 430 sends the measurement gap pattern configuration to the UE, which the UE 110 receives in block 435. The NW node 310 schedules and performs data transmissions (and/or receptions) accordingly based on the known measurement gap pattern. See block 440. This is one example of block 325 of FIG. 3. The UE then receives and/or transmits data according to scheduling and use measurement gap pattern configured by the network for RRM measurements. See block 445, which is one example of block 330 of FIG. 3.

The UE 110, in block 340, reports results of the radio resource measurements to the NW node 310. The NW node 310 receives reporting of results of radio resource measurements made by the UE 110 according to the aligned radio resource measurement relaxation state. See block 350.

In terms of the information that may be reported in block 415 by the UE 110 to the NW node 310, one or more of the following are possible:
1) The UE's intra/inter-frequency/inter-RAT non-serving cell measurement activity, e.g., either UE is relaxing or not relaxing the measurements, or the level of relaxation;
2) Whether low mobility or not-at-cell-edge or both condition(s) is(are) fulfilled;
3) Whether a cell quality (or a beam quality) threshold for controlling whether the UE is required to perform measurements on non-serving cells is fulfilled or not; and/or
4) The UE's preferred measurement gap configuration, e.g., based on the amount of non-serving cell measurements (e.g., a higher amount of non-serving cell measurements could require longer measurement gaps).

For the sending the indication of the measurement gap pattern configuration to the UE in block 430, the following might be used:
1) A technique similar to or the same as the current standard specification of 3GPP TS 38.331 in Section 5.5.2.9, by configuring the UE with MeasGapConfig IE, a gapFR1 and/or a gapFR2 and/or gapUE, to set up GapConfig. The IE GapConfig provides the gapOffset to determine the timing location (offset), period and length of the measurement gap; or
2) The UE may be configured with a default measurement gap and an adapted measurement gap. These are described in more detail below.

Referring to FIG. 5, this figure is a logic flow and signaling diagram for radio resource measurement activity information reporting and scheduling for a second alternative example building on FIG. 3. FIG. 5 also illustrates the operation of an exemplary method, a result of execution of computer program instructions embodied on a computer readable memory, functions performed by logic implemented in hardware, and/or interconnected means for performing functions in accordance with an exemplary embodiment. The blocks in FIG. 5 are performed by the UE 110 or NW node 310, controlled by their respective control modules 140 or 150.

Many of the blocks in FIG. 5 have been described in reference to FIG. 4, so only the differences are described herein. In this example, the network provides the UE with more control over which measurement gap pattern configuration is used. To do this, the NW node 310 sends the UE 110 multiple measurement gap pattern configurations. There are a number of possibilities for this to occur.

As a first possibility, in block 507, the NW node 310 sends multiple measurement gap pattern configurations to the UE. The UE receives these in block 512.

In another possibility, in block 525, the NW node 310 uses information received from the UE for configuring multiple measurement gap pattern configurations for the UE. The NW node 310 sends, in block 530, indications of multiple measurement gap pattern configurations to the UE. The UE 110 receives the indications in block 535.

Blocks 507 and 530 may be separate and alternative options. As another possibility, block 507 could be used to load a large (e.g., 10 or more) measurement gap pattern configurations into the UE 110, and block 530 could be used by the NW node 310 to pare that down to a few (e.g., 3 or 4 choices). As a further possibility, block 507 could load an initial set of measurement gap pattern configurations, and block 530 could revise one or more of the measurement gap pattern configurations in the set or potentially replace the set completely with a different set of measurement gap pattern configurations. Other options are possible.

The UE 110 selects a measurement gap pattern configuration from the multiple measurement gap pattern configurations in block 536. The UE 110 in block 537 reports the selected measurement gap pattern configuration to the NW node 310, which receives the report of the selected measurement gap pattern configuration in block 538. In block 540, the NW node 310 schedules and performs data transmissions (and/or receptions) accordingly based on the selected measurement gap pattern. In block 545, the UE 110 receives and/or transmits data according to scheduling and uses the selected measurement gap pattern for RRM measurements.

As previously described, the UE 110, in block 536, selects its applied measurement gap configuration based on the configurations by the network, after determining which relaxed state would be used. This selection may be performed via the following:
1) The network configures the UE with multiple measurement gap configurations, and the UE selects a measurement gap configuration from them;
2) The network configures the UE with a bitmap/field so that the UE can determine the subset of measurement gaps to be used;
3) The network configures the UE with different measurement gap periodicity for different measurement activity conditions, so that the UE adapts the provided measurement gap configuration based on the applied measurement activity;
4) The network configures the UE with multiple MeasGapConfig IEs that correspond to the applied measurement relaxation states, e.g., MeasGapConfig_lowMob when the UE is in low mobility; MeasGapConfig_cellCentre when the UE in the cell center; MeasGapConfig_inferF when the UE is in a condition that may cease or relax all inter-frequency criterions;
5) The measurement gap configuration and the unused measurement gap occasions may be associated with C-DRX; and/or
6) The network configures UE with scaling factors of N or M values (described in more detail below), so that the UE can determine which measurement gap occasions are assumed to be used for measurements or which can be ignored by UE.

How the UE reports its applied measurement gap configuration/pattern to the network (see block 537) may be performed via the following:
1) The UE reports to the network on its applied measurement gap configuration index, or whether reduction on the available measurement gap occasions is applied or not; and/or
2) The UE reports the selected/applied measurement gap configuration to the network by using UE assistance information, which includes gap for FR1/FR2, UE specific gap which applies to all frequencies, gap offset, gap length, gap repetition period, gap timing advance.

Now than an introduction has been provided, additional details are provided. In one embodiment, the UE reports or is configured to report information on its intra/inter-frequency/inter-RAT non-serving cell measurement activity. See, e.g., block 415 of FIGS. 4 and 5.

In one embodiment, the measurement activity information in the paragraph above can be one or more of the following: UEs RRM measurement relaxation (either UE is relaxing/not relaxing the measurements or the level of relaxation), whether low mobility or not-at-cell-edge or both condition(s) is (are) fulfilled, whether a cell quality (or a beam quality) threshold for controlling whether the UE is required to perform measurements on non-serving cells is fulfilled or not.

In one example embodiment, the threshold may be a cell quality or one or more sets of ssb-RSRP used to derive the cell quality level (e.g., RSRP based on SS/PBCH block(s) measurement) or one or more of csi-RSRP corresponding to the cell level RSRP based on CSI-RS(s) measurement.

In one embodiment, the network uses the above information for UL/DL scheduling. In one embodiment, the network uses the above information for configuring suitable measurement gap configuration for the UE. In one embodiment, the network determines based on the measurement activity information reported by the UE whether and which measurement gap the UE is using.

In one embodiment, the UE is configured with multiple measurement gap configurations and the UE selects a measurement gap configuration for its use, e.g., based on its non-serving cell measurement activity. See, e.g., block 536 of FIG. 5. In some examples, the UE reports selected measurement gap configuration to the network. See, e.g., block 537 of FIG. 5. See also the following examples: as an example, the UE may be configured to trigger (or is configured to provide an indication) when the UE relaxes RRM measurements; as an example, reporting for non-serving cells may relate to inter-frequency cell measurement activity or the relaxation for inter-frequency cell measurements. In one embodiment, when the UE determines that the UE cannot relax RRM measurements anymore, the UE indicates this fact to the network.

In one example embodiment, the UE may be configured with a default measurement gap and an adapted measurement gap. If any trigger conditions apply, the UE reverts back to the default measurement gap. The trigger conditions may include one or more of the following:
1) In one example, the trigger condition may be when the UE determines that RRM measurements cannot be relaxed (e.g., an exit condition);
2) The UE initiates RACH (e.g., for SR or BFR);
3) The UE triggers SR on PUCCH;
4) A measurement reporting event (e.g., A2/A3/A4) has been triggered (e.g., for inter-frequency cell, or intra-frequency cell or both); and/or
5) The UE may indicate that the UE has reverted back to the default gap (e.g., based on an explicit indication that the UE does not relax measurements, or the reversion may be assumed implicitly e.g., based on RACH/RRC level report).

In one embodiment, a specific gap pattern configuration or set of MG parameters may be associated with RRM measurement relaxation status of the UE. As an example, specific status, e.g., relaxed RRM measurements or “normal mode” non-relaxed status is associated to a specific MG pattern configuration/set of values. Furthermore, in case of multiple relaxation levels, each level may be associated with at least one measurement gap pattern, wherein the same gap pattern may be shared by one or more relaxation levels.

In one embodiment, the UE adapts the provided measurement gap configuration based on the applied measurement activity. In one embodiment, the UE is provided additional parameters to determine which measurement gaps are to be used (or assumed not to be used) or how the measurement gap pattern is adapted. In one possible embodiment, the UE is provided a bitmap/field to determine the subset of measurement gaps to be used (or assumed not to be available for measurement). In one embodiment, the UE is provided different measurement gap periodicity for different measurement activity conditions.

In one embodiment, the measurement gap configuration and the unused measurement gap occasions may be associated with C-DRX as follows:
1) as an example, the UE may perform measurements according to relaxed measurement configuration and the UE may determine not to use at least one measurement gap duration within the periodic gap pattern;
2) based on the determination, the UE may further determine whether C-DRX active time (on duration) overlaps fully or at least partially on the measurement gap that UE has determined not to use:
   a) if the on-duration overlaps based on the determination, the UE is assumed to be available for scheduling/the UE is assumed to monitor PDCCH;
   b) the unused measurement gap durations in the gap pattern are known by network and UE, e.g., based on UE indication.

In one embodiment, the UE reports its preferred measurement gap configuration, e.g., based on the amount of non-serving cell measurements, using a UE assistance information procedure, including one or more of the following: gap for FR1/FR2, UE specific gap which applies to all frequencies, gap offset, gap length, gap repetition period, gap timing advance.

In one embodiment, the measurement gaps occurring during drx-onDurationTimer or in general during Active Time are suppressed, based on the relaxed RRM measurement criterion. In some examples, the NW can deduce the measurement gaps the UE suppressed, based on the UE reporting of the UE reports. That is, suppressed measurement gaps are not reported. In another embodiment, the measurement gaps occurring during drx-onDurationTimer or in general during Active Time are prioritized to be kept. This would ensure the UE can save power the most during DRX.

It is noted that the method to adapt/trigger the relaxed measurement activity to the CONNECTED mode UE is outside the scope of this document.

In further detail, in one possible implementation of the proposed embodiments, the UE provides an RRC message to the network indicating what is the applied measurement configuration e.g., by indicating the applied measurement gap configuration index, or whether reduction on the available measurement gap occasions is applied (or not). See, e.g., block 415 of FIGS. 4 and 5.

In one possible implementation of the proposed embodiments, the indication can be separately informed for FR1 gaps, FR2 gaps and/or UE specific gaps. This could occur, e.g., in blocks 430 of FIG. 4 or 530 of FIG. 5

In one possible implementation of the proposed embodiments, the UE 110 may be provided by the network with two (or more) MeasGapConfig IEs that correspond to the applied measurement relaxation state. This could occur in blocks 507 and/or 530. For example, MeasGapConfig_lowMob, applicable when UE considers to be in low mobility based on defined criterion(s), and MeasGapConfig_cellCentre, applicable when UE considers to be in cell center (centre) conditions based on defined criterion(s). As an additional possibility, MeasGapConfig_inferF, applicable when UE considers itself to be in such a condition that the UE may cease or relax all inter-frequency measurement based on a defined criterion or defined criteria. In one additional implementation of the proposed embodiments, the relaxation is applied to intra-frequency measurements so that the measurement gaps assigned for intra-frequency measurements may be adapted.

In one possible implementation of the proposed embodiments, to determine which measurement gap occasions are assumed to be available for measurement or are blocked, the UE 110 is provided with a bitmap that determines those measurement gaps that are assumed to be active/usable for measurements within a certain period. This could be provided in block 430 as a measurement gap pattern configuration or possibly in blocks 507 or 530. For example, the UE is provided with a bitmap/field length of M, which is applied for M consecutive measurement gap occasions (and repeated for every M measurement gap periods). In another example, the UE is provided with a bitmap of length M and a period of N (in measurement gap periods), where M>N, and the UE determines the applied gaps based most significant bits (or least significant bits) of the bitmap/field.

In one possible implementation of the proposed embodiments to determine which measurement gap occasions are assumed to be used for measurements or which can be ignored by UE (i.e., the UE may determine not to use the gap for measurements), the following may be used, e.g., as part of blocks 430, 507, and/or 530.
1) The network may signal an integer value e.g., N1=2, which is used by the UE to determine MG occasions which can be ignored/skipped/not used by UE). The value 2 means that every second MG occasion, the UE is not required to perform RRM measurements or the UE may ignore the gap. In this example, N1=3 means that every third gap can be ignored/not used.
2) Alternatively or additionally, the network may signal an integer value e.g., N1=½, which is used by the UE to determine MG occasions which can be ignored/skipped/not used by UE). A value N2=⅔ means that UE may ignore 2 gaps out of 3.
3) Alternatively or additionally, a value may be provided to UE that is used to apply scaling of MG length, e.g., a value N2=2 causes the UE to shorten the MGL (measurement gap length) by factor of 2. Alternatively, a fractional number N2=½ or ⅓ may be used for a similar purpose.
4) Alternatively, the numbers may be interpreted vice versa, i.e., N1=⅔ means that UE can ignore 1 gap out of 3. Or N1=3 means that UE is required to perform measurements on every third MG occasion in the gap pattern.

In one possible implementation of the proposed embodiments, the UE determines the measurement gap occasions that are not available for measurements when measurement relaxations are applied, based on possible overlap with C-DRX onDurationTimer. This could be performed, e.g., in blocks 445 or 545. For example, if the measurement relaxation is applied, and a measurement gap occasion falls partially or fully overlapping with onDurationTimer, the UE assumes that the measurement gap is not available for measurement and can be used for data scheduling by the network. In alternative example, the portion of the measurement gap that overlaps with the C-DRX onDurationTimer is assumed not be available for measurements, and can be used by network to schedule data. In some alternative embodiments, the whether the measurement gap that overlaps the C-DRX onDurationTimer can be assumed to be available for measurements depends on the WUS/DCP indication, so that if the UE is not required to start the PDCCH monitoring (indicated via DCP/WUS), the UE may assume the (subsequent) measurement gap occasion overlapping with onDurationTimer can be used for inter-frequency measurements.

In one possible implementation of the proposed embodiments, the UE 110 determines the applied measurement activity based on the applied measurement requirements, such as measurement reporting delay or measurement accuracy. This could be implemented in block 536, where a measurement gap pattern configuration is selected. In one possible implementation of the proposed embodiments, the UE measurement requirements for measurement reporting delay and/or measurement accuracy are determined based on requirements defined in 3GPP TS 38.133 so that UE can fulfill these requirements. In one possible implementation of the proposed embodiments, the UE determines the applied relaxation to the applied measurement activity.

In one possible implementation of the proposed embodiments, the UE applies the relaxation to the measurement activity due to adjustment to the relaxation applied to measurement requirements, such as measurement evaluation time.

In one possible implementation of the proposed embodiments, the network, based on the information provided on the UE RRM relaxation state, determines a subset of configured measurement gaps that can be used for scheduling DL(/UL) data to(/from) the UE based on the information provided by the UE, where the information is related to the measurement relaxation status of the UE or to the applied measurement gap configuration applied by the UE. See, e.g., blocks 440 and 540.

The following are additional examples.

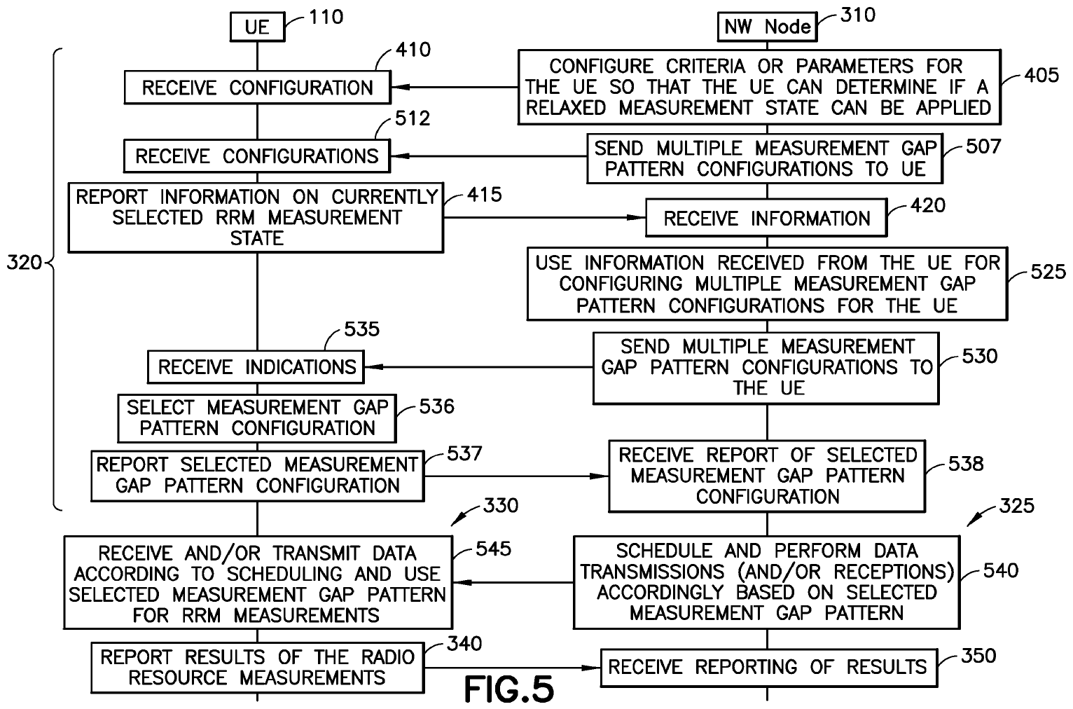

Turning to FIG. 6, this figure is a logic flow diagram performed by a user equipment for measurement activity reporting and usage, in accordance with an exemplary embodiment. This figure illustrates the operation of an exemplary method, a result of execution of computer program instructions embodied on a computer readable memory, functions performed by logic implemented in hardware, and/or interconnected means for performing functions in accordance with an exemplary embodiment. The blocks in FIG. 6 are performed by a UE 110, controlled by a control module 140.

In block 610, at a UE 110 in a connected mode with a wireless NW 100 (e.g., a NW node 310) of a wireless network, the UE 110 transmits activity information to the wireless NW 100. In block 620, the UE 110 performs measurements.

In the examples that follow, the logic flow diagram of FIG. 6 is referred to as example 1. Example 2. The method of example 1, wherein the measurements comprise one or more of the following:
radio resource management measurements, or radio link monitoring measurements, or serving cell measurements, or non-serving cell measurements.

Example 3. The method of any one of examples 1 or 2, wherein user equipment performs the measurements with or without one or more measurement gaps.

Example 4. The method of any one of examples 1 to 3, further comprising adapting by the user equipment a measurement gap provided by the wireless network based on an applied measurement activity.

Example 5. The method of any one of examples 1 to 3, further comprising selecting by the user equipment a measurement gap based on an applied measurement activity.

Example 6. The method of any one of examples 1 to 3, further comprising determining by the user equipment whether or not to use a measurement gap based on an applied measurement activity.

Example 7. The method of any of examples 1 to 6, wherein measurement activity information is provided via physical layer signaling or medium access control layer signaling or radio resource control layer signaling.

Example 8. The method of example 7, wherein the medium access control layer signaling comprises using at least one control element for medium access control.

Example 9. The method of example 7, wherein the radio resource control layer signaling comprises one or more of a measurement report, user equipment assistance information, or any other radio resource control message.

Example 10. The method of any one of examples 1 to 9, wherein the measurement activity information comprises indication for one or more of the following:
radio resource management measurement relaxation level or radio link monitoring measurement level or low mobility condition information, or not-at-cell-edge condition information, or whether a threshold for controlling whether the user equipment is required to perform measurements on non-serving cells is fulfilled or not, or a selected measurement gap configuration, or the user equipment is not able or allowed to relax the measurements anymore, or a preferred measurement gap configuration of the user equipment.

Example 11. The method of example 10, wherein the preferred measurement gap configuration comprises one or more of the following:
a gap for frequency range 1, a gap for frequency range 2, a user equipment-specific gap which applies to all frequencies, a gap offset, a gap length, a gap repetition period, or a gap timing advance.

Example 12. The method of example 10, wherein the radio resource management measurement relaxation level comprises indication of one or more of the following:
no radio resource management measurements or relaxed radio resource management measurements or regular radio resource management measurements or relaxed radio link monitoring measurements or regular radio link monitoring measurements.

Example 13. The method of example 10, wherein the threshold comprises a threshold for one or more of the following:
cell quality or one or more sets of synchronization signal block-reference signal received power used to derive a cell quality level or one or more of channel state information-reference signal received power corresponding to the cell-level reference signal received power based on one or more channel state information-reference signals measurement.

Example 14. The method of example 10, wherein the preferred measurement gap configuration is determined based on an amount of non-serving cell measurements.

Example 15. The method of example 10, wherein selection by the user equipment comprises selection of measurement gap configurations from multiple measurement gap configurations provided by the wireless network.

Example 16. The method of any one of examples 1 to 15, wherein the measurements are radio resource management measurements, and wherein the method further comprises reporting by the user equipment results of the radio resource management measurements toward the wireless network.

Example 17. The method of any one of examples 1 to 16, wherein the measurement activity information indicates whether the user equipment is relaxing or not relaxing the measurements, or indicates a level of relaxation of the measurements.

Example 18. The method of any one of examples 1 to 16, further comprising receiving by the user equipment configuration from the network node indicating the user equipment is to report the measurement activity information to the network node.

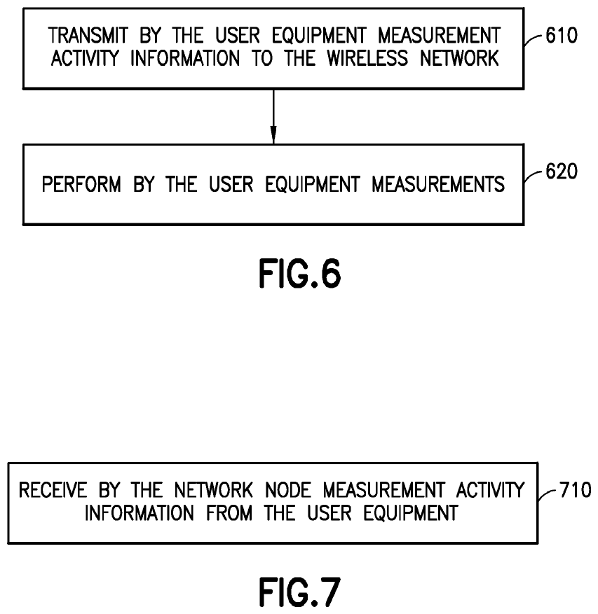

Referring to FIG. 7, this figure is a logic flow diagram performed by a network node for measurement activity reporting and usage, in accordance with an exemplary embodiment. This figure illustrates the operation of an exemplary method, a result of execution of computer program instructions embodied on a computer readable memory, functions performed by logic implemented in hardware, and/or interconnected means for performing functions in accordance with AN exemplary embodiment. The blocks in FIG. 7 are performed a network (NW) node 310, controlled by a control module 150. The NW node 310 is an element in network 100, and may be a RAN node 170 or some element in the RAN node 170, such an RRH or a DU/RU (see reference 196 in FIG. 1).

In block 710, at a NW node 310, having configured UE(s) 110 to a connected mode, receives by the NW node 310 measurement activity information from the UE(s) 110.

In the examples that follow, the logic flow diagram of FIG. 7 is referred to as example 19. Example 20. The method of example 19, further comprising receiving reports corresponding measurements made by the user equipment.

Example 21. The method of example 20, wherein the measurements comprise one or more of the following:
radio resource management measurements, or radio link monitoring measurements, or serving cell measurements, or non-serving cell measurements.

Example 22. The method of any one of examples 20 or 21, wherein user equipment performs the measurements with or without the one or more measurement gaps.

Example 23. The method of any one of examples 19 to 22, further comprising configuring by the network node the user equipment to allow the user equipment to adapt a measurement gap provided by the network node based on a measurement activity applied by the user equipment.

Example 24. The method of any one of examples 19 to 22, further comprising configuring by the network node the user equipment to select a measurement gap based on an applied measurement activity.

Example 25. The method of any one of examples 19 to 22, further comprising configuring by the network node the user equipment to determine whether or not to use a measurement gap based on an applied measurement activity.

Example 26. The method of any of examples 19 to 25, wherein the measurement activity information is received via physical layer signaling or medium access control layer signaling or radio resource control layer signaling.

Example 27. The method of example 26, wherein the medium access control layer signaling comprises using at least one control element for medium access control.

Example 28. The method of example 26, wherein the radio resource control layer signaling comprises one or more of a measurement report, user equipment assistance information, or any other radio resource control message.

Example 29. The method of any one of examples 19 to 28, wherein the measurement activity information comprises indication for one or more of the following:
radio resource management measurement relaxation level or radio link monitoring measurement level or low mobility condition information, or not-at-cell-edge condition information, or whether a threshold for controlling whether the user equipment is required to perform measurements on non-serving cells is fulfilled or not, or a selected measurement gap configuration, or the user equipment is not able or allowed to relax the measurements anymore, or a preferred measurement gap configuration of the user equipment.

Example 30. The method of example 29, wherein the preferred measurement gap configuration comprises one or more of the following:
a gap for frequency range 1, a gap for frequency range 2, a user equipment-specific gap which applies to all frequencies, a gap offset, a gap length, a gap repetition period, or a gap timing advance.

Example 31. The method of example 29, wherein the radio resource management measurement relaxation level comprises indication of one or more of the following:
no radio resource management measurements or relaxed radio resource management measurements or regular radio resource management measurements or relaxed radio link monitoring measurements or regular radio link monitoring measurements.

Example 32. The method of example 29, wherein the threshold comprises a threshold for one or more of the following:
cell quality or one or more sets of synchronization signal block-reference signal received power used to derive a cell quality level or one or more of channel state information-reference signal received power corresponding to the cell-level reference signal received power based on one or more channel state information-reference signals measurement.

Example 33. The method of example 29, wherein the preferred measurement gap configuration is determined based on an amount of non-serving cell measurements.

Example 34. The method of example 29, wherein selection by the user equipment comprises selection of measurement gap configurations from multiple measurement gap configurations provided by the network node.

Example 35. The method of any one of examples 19 to 34, wherein the measurements are radio resource management measurements, and wherein the method further comprises receiving, by the network node and from the user equipment, results of the radio resource management measurements.

Example 36. The method of any one of examples 19 to 35, wherein the measurement activity information indicates whether the user equipment is relaxing or not relaxing the measurements, or indicates a level of relaxation of the measurements.

Example 37. The method of any one of examples 19 to 36, further comprising the network node configuring the user equipment to report the measurement activity information to the network node.

Example 38. The method of any one of claims 19 to 37, wherein the user equipment is a single user equipment or multiple user equipment.

Example 39. The method of any one of claims 19 to 38, wherein the network node comprises one of the following: a gNB; an eNB; a node forming part of the gNB; a node forming part of the eNB; a ng-eNB; multiple gNBs; multiple eNBs; a RRH or multiple RRHs; or a DU or multiple DUs.

Example 40. A computer program, comprising code for performing the methods of any of examples 1 to 39, when the computer program is run on a computer.

Example 41. The computer program according to example 40, wherein the computer program is a computer program product comprising a computer-readable medium bearing computer program code embodied therein for use with the computer.

Example 42. The computer program according to example 40, wherein the computer program is directly loadable into an internal memory of the computer

Example 43. An apparatus, comprising means for performing:
at a user equipment in a connected mode with a wireless network, transmitting by the user equipment measurement activity information to the wireless network; and
performing by the user equipment measurements.

Example 44. The apparatus of example 43, wherein the measurements comprise one or more of the following:
radio resource management measurements, or radio link monitoring measurements, or serving cell measurements, or non-serving cell measurements.

Example 45. The apparatus of any one of examples 43 or 44, wherein user equipment performs the measurements with or without one or more measurement gaps.

Example 46. The apparatus of any one of examples 43 to 45, wherein the means are further configured to perform: adapting by the user equipment a measurement gap provided by the wireless network based on an applied measurement activity.

Example 47. The apparatus of any one of examples 43 to 45, wherein the means are further configured to perform: selecting by the user equipment a measurement gap based on an applied measurement activity.

Example 48. The apparatus of any one of examples 43 to 45, wherein the means are further configured to perform: determining by the user equipment whether or not to use a measurement gap based on an applied measurement activity.

Example 49. The apparatus of any of examples 43 to 48, wherein measurement activity information is provided via physical layer signaling or medium access control layer signaling or radio resource control layer signaling.

Example 50. The apparatus of example 49, wherein the medium access control layer signaling comprises using at least one control element for medium access control.

Example 51. The apparatus of example 49, wherein the radio resource control layer signaling comprises one or more of a measurement report, user equipment assistance information, or any other radio resource control message.

Example 52. The apparatus of any one of examples 43 to 51, wherein the measurement activity information comprises indication for one or more of the following:
radio resource management measurement relaxation level or radio link monitoring measurement level or low mobility condition information, or not-at-cell-edge condition information, or whether a threshold for controlling whether the user equipment is required to perform measurements on non-serving cells is fulfilled or not, or a selected measurement gap configuration, or the user equipment is not able or allowed to relax the measurements anymore, or a preferred measurement gap configuration of the user equipment.

Example 53. The apparatus of example 52, wherein the preferred measurement gap configuration comprises one or more of the following:
a gap for frequency range 1, a gap for frequency range 2, a user equipment-specific gap which applies to all frequencies, a gap offset, a gap length, a gap repetition period, or a gap timing advance.

Example 54. The apparatus of example 52, wherein the radio resource management measurement relaxation level comprises indication of one or more of the following:
no radio resource management measurements or relaxed radio resource management measurements or regular radio resource management measurements or relaxed radio link monitoring measurements or regular radio link monitoring measurements.

Example 55. The apparatus of example 52, wherein the threshold comprises a threshold for one or more of the following:
cell quality or one or more sets of synchronization signal block-reference signal received power used to derive a cell quality level or one or more of channel state information-reference signal received power corresponding to the cell-level reference signal received power based on one or more channel state information-reference signals measurement.

Example 56. The apparatus of example 52, wherein the preferred measurement gap configuration is determined based on an amount of non-serving cell measurements.

Example 57. The apparatus of example 52, wherein selection by the user equipment comprises selection of measurement gap configurations from multiple measurement gap configurations provided by the wireless network.

Example 58. The apparatus of any one of examples 43 to 57, wherein the measurements are radio resource management measurements, and wherein the apparatus further comprises reporting by the user equipment results of the radio resource management measurements toward the wireless network.

Example 59. The apparatus of any one of examples 43 to 58, wherein the measurement activity information indicates whether the user equipment is relaxing or not relaxing the measurements, or indicates a level of relaxation of the measurements.

Example 60. The apparatus of any one of examples 43 to 58, wherein the means are further configured to perform: receiving by the user equipment configuration from the wireless network indicating the user equipment is to report the measurement activity information to the wireless network.

Example 61. An apparatus, comprising means for performing:
at a network node having configured user equipment to a connected mode, receiving by the network node measurement activity information from the user equipment.

Example 62. The apparatus of example 61, wherein the means are further configured to perform: receiving reports corresponding measurements made by the user equipment.

Example 63. The apparatus of example 62, wherein the measurements comprise one or more of the following:
radio resource management measurements, or radio link monitoring measurements, or serving cell measurements, or non-serving cell measurements.

Example 64. The apparatus of any one of examples 62 or 63, wherein user equipment performs the measurements with or without the one or more measurement gaps.

Example 65. The apparatus of any one of examples 61 to 64, wherein the means are further configured to perform: configuring by the network node the user equipment to allow the user equipment to adapt a measurement gap provided by the network node based on a measurement activity applied by the user equipment.

Example 66. The apparatus of any one of examples 61 to 64, wherein the means are further configured to perform: configuring by the network node the user equipment to select a measurement gap based on an applied measurement activity.

Example 67. The apparatus of any one of examples 61 to 64, wherein the means are further configured to perform: configuring by the network node the user equipment to determine whether or not to use a measurement gap based on an applied measurement activity.

Example 68. The apparatus of any of examples 61 to 67, wherein the measurement activity information is received via physical layer signaling or medium access control layer signaling or radio resource control layer signaling.

Example 69. The apparatus of example 68, wherein the medium access control layer signaling comprises using at least one control element for medium access control.

Example 70. The apparatus of example 68, wherein the radio resource control layer signaling comprises one or more of a measurement report, user equipment assistance information, or any other radio resource control message.

Example 71. The apparatus of any one of examples 61 to 70, wherein the measurement activity information comprises indication for one or more of the following:
radio resource management measurement relaxation level or radio link monitoring measurement level or low mobility condition information, or not-at-cell-edge condition information, or whether a threshold for controlling whether the user equipment is required to perform measurements on non-serving cells is fulfilled or not, or a selected measurement gap configuration, or the user equipment is not able or allowed to relax the measurements anymore, or a preferred measurement gap configuration of the user equipment.

Example 72. The apparatus of example 71, wherein the preferred measurement gap configuration comprises one or more of the following:
a gap for frequency range 1, a gap for frequency range 2, a user equipment-specific gap which applies to all frequencies, a gap offset, a gap length, a gap repetition period, or a gap timing advance.

Example 73. The apparatus of example 71, wherein the radio resource management measurement relaxation level comprises indication of one or more of the following:
no radio resource management measurements or relaxed radio resource management measurements or regular radio resource management measurements or relaxed radio link monitoring measurements or regular radio link monitoring measurements.

Example 74. The apparatus of example 71, wherein the threshold comprises a threshold for one or more of the following:
cell quality or one or more sets of synchronization signal block-reference signal received power used to derive a cell quality level or one or more of channel state information-reference signal received power corresponding to the cell-level reference signal received power based on one or more channel state information-reference signals measurement.

Example 75. The apparatus of example 71, wherein the preferred measurement gap configuration is determined based on an amount of non-serving cell measurements.

Example 76. The apparatus of example 71, wherein selection by the user equipment comprises selection of measurement gap configurations from multiple measurement gap configurations provided by the network node.

Example 77. The apparatus of any one of examples 61 to 76, wherein the measurements are radio resource management measurements, and wherein the apparatus further comprises receiving, by the network node and from the user equipment, results of the radio resource management measurements.

Example 78. The apparatus of any one of examples 61 to 77, wherein the measurement activity information indicates whether the user equipment is relaxing or not relaxing the measurements, or indicates a level of relaxation of the measurements.

Example 79. The apparatus of any one of examples 61 to 78, wherein the means are further configured to perform: the network node configuring the user equipment to report the measurement activity information to the network node.

Example 80. The apparatus of any one of examples 61 to 79, wherein the user equipment is a single user equipment or multiple user equipment.

Example 81. The apparatus of any one of examples 61 to 80, wherein the network node comprises one of the following: a gNB; an eNB; a node forming part of the gNB; a node forming part of the eNB; a ng-eNB; multiple gNBs; multiple eNBs; a RRH or multiple RRHs; or a DU or multiple DUs.

Example 82. The apparatus of any preceding apparatus example wherein the means comprises:
at least one processor; and
at least one memory including computer program code, the at least one memory and computer program code configured to, with the at least one processor, cause the performance of the apparatus.

Example 83. An apparatus, comprising:
one or more processors; and
one or more memories including computer program code,
wherein the one or more memories and the computer program code are configured, with the one or more processors, to cause the apparatus to:
at a user equipment in a connected mode with a wireless network, transmit by the user equipment measurement activity information to the wireless network; and
perform by the user equipment measurements.

Example 84. A computer program product comprising a computer-readable storage medium bearing computer program code embodied therein for use with a computer, the computer program code comprising:
code, at a user equipment in a connected mode with a wireless network, for transmitting by the user equipment measurement activity information to the wireless network; and
code for performing by the user equipment measurements.

Example 85. An apparatus, comprising:
one or more processors; and
one or more memories including computer program code,
wherein the one or more memories and the computer program code are configured, with the one or more processors, to cause the apparatus to:
at a network node having configured user equipment to a connected mode, receive by the network node measurement activity information from the user equipment.

Example 86. A computer program product comprising a computer-readable storage medium bearing computer program code embodied therein for use with a computer, the computer program code comprising:
code, at a network node having configured user equipment to a connected mode, for receiving by the network node measurement activity information from the user equipment.

Without in any way limiting the scope, interpretation, or application of the examples appearing below, a technical effect and advantage of one or more of the example embodiments disclosed herein is improved (e.g., optimized) UL/DL scheduling based on the knowledge of the UE measurement activity. Another technical effect and advantage of one or more of the example embodiments disclosed herein is improved system capacity due to reduced scheduling restrictions due to measurement gaps.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects are set out above, other aspects comprise other combinations of features from the described embodiments, and not solely the combinations described above.

It is also noted herein that while the above describes example embodiments of the invention, these descriptions should not be viewed in a limiting sense. Rather, there are several variations and modifications which may be made without departing from the scope of the present invention.

The following abbreviations that may be found in the specification and/or the drawing figures are defined as follows:
3GPP third generation partnership project
5G fifth generation
5GC 5G core network
AMF access and mobility management function
BFR beam failure recovery
BWP bandwidth part
C-DRX DRX in the Connected state
CSI channel state information
CU central unit
DCI Downlink Control Information.
DCP DCI Format Scrambled with PS-RNTI
DL downlink (from network to UE)
DRX discontinuous reception
DU distributed unit
eNB (or eNodeB) evolved Node B (e.g., an LTE base station)
EN-DC E-UTRA-NR dual connectivity en-gNB or En-gNB node providing NR user plane and control plane protocol terminations towards the UE, and acting as secondary node in EN-DC
E-UTRA evolved universal terrestrial radio access, i.e., the LTE radio access technology
FR1. FR2 frequency range 1, frequency range 3 eMMB enhanced Mobile Broadband
gNB (or gNodeB) base station for 5G/NR, i.e., a node providing NR user plane and control plane protocol terminations towards the UE, and connected via the NG interface to the 5GC
IE information element
I/F interface
LTE long term evolution
MAC medium access control
MAC CE MAC control element
MG measurement gap
MGL measurement gap length
MME mobility management entity
ms milliseconds
ng or NG next generation
ng-eNB or NG-eNB next generation eNB
NR new radio
N/W or NW network
PDCCH physical downlink control channel
PDCP packet data convergence protocol
PHY physical layer
PS-RNTI Power Saving-Radio Network Temporary Identifier
PUCCH physical uplink control channel
RAN radio access network
Rel or REL release
REDCAP reduced capability
RLC radio link control
RLM radio link monitoring
RS reference signal
RRH remote radio head
RRC radio resource control
RRM radio resource management
RSRP Reference Signal Received Power
RSRQ Reference Signal Received Quality
RU radio unit
Rx receiver
RACH random access channel
SDAP service data adaptation protocol
SGW serving gateway
SI study item
SMF session management function
SSB synchronization signal block
SS/PBCH synchronization signal/physical broadcast channel
TS technical specification
Tx transmitter
UE user equipment (e.g., a wireless, typically mobile device)
UL uplink (from the UE to the network)
UPF user plane function
WI work item
WUS wake up signal

1-49. (canceled)

50. A method performed by a terminal device in a connected mode with a network device, comprising:
receiving from the network device, configuration information indicating the terminal device to report measurement activity information applied at the terminal device, wherein the measurement activity information indicating whether or not measurement relaxation in measurements on the network device is applied at the terminal device;
determining the measurement activity information based on whether or not a low mobility condition or a cell quality condition is fulfilled at the terminal device, wherein the low mobility condition or the cell quality condition is configured by the network device for the measurement relaxation; and
transmitting by the terminal device measurement activity information to the wireless network.

51. The method of claim 50, wherein the measurements on the network device comprise one or more of the following:
radio resource management measurements, or radio link monitoring measurements, or serving cell measurements, or non-serving cell measurements.

52. The method of claim 50, wherein the measurement activity information is provided via physical layer signaling or medium access control layer signaling or radio resource control layer signaling,

53. The method of claim 50, wherein the radio resource control layer signaling comprises one or more of a measurement report, user equipment assistance information, or any other radio resource control message.

54. The method of claim 50, wherein the measurement activity information further comprises indication for one or more of the following:
radio resource management measurement relaxation level or radio link monitoring measurement level or low mobility condition information, or not-at-cell-edge condition information, or whether a threshold for controlling whether the terminal device is required to perform measurements on non-serving cells is fulfilled or not.

55. A terminal device in a connected mode with a network device, comprising:
at least one processor; and
at least one memory storing instructions that, when executed by the at least one processor, cause the first apparatus at least to:
receive, from the network device, configuration information indicating the terminal device to report measurement activity information applied at the terminal device, wherein the measurement activity information indicating whether or not measurement relaxation in measurements on the network device is applied at the terminal device;
determine the measurement activity information based on whether or not a low mobility condition or a cell quality condition is fulfilled at the terminal device, wherein the low mobility condition or the cell quality condition is configured by the network device for the measurement relaxation; and
transmit by the terminal device measurement activity information to the wireless network.

56. The terminal device of claim 55, wherein the measurements on the network device comprise one or more of the following:
radio resource management measurements, or radio link monitoring measurements, or serving cell measurements, or non-serving cell measurements.

57. The terminal device of claim 55, wherein the measurement activity information is provided via physical layer signaling or medium access control layer signaling or radio resource control layer signaling.

58. The terminal device of claim 57, wherein the radio resource control layer signaling comprises one or more of a measurement report, user equipment assistance information, or any other radio resource control message.

59. The terminal device of claim 55, wherein the measurement activity information further comprises indication for one or more of the following:
radio resource management measurement relaxation level or radio link monitoring measurement level or low mobility condition information, or not-at-cell-edge condition information, or whether a threshold for controlling whether the terminal device is required to perform measurements on non-serving cells is fulfilled or not.

60. The terminal device of claim 59, wherein the radio resource management measurement relaxation level comprises indication of one or more of the following:
no radio resource management measurements, or relaxed radio resource management measurements, or regular radio resource management measurements, or relaxed radio link monitoring measurements, or regular radio link monitoring measurements.

61. The terminal device of claim 59, wherein the threshold comprises a threshold for one or more of the following:
cell quality or one or more sets of synchronization signal block-reference signal received power used to derive a cell quality level or one or more of channel state information-reference signal received power corresponding to cell-level reference signal received power based on one or more channel state information-reference signals measurement.

62. A network device having configured a terminal device to a connected mode, comprising:
at least one processor; and
at least one memory storing instructions that, when executed by the at least one processor, cause the first apparatus at least to:
configure, by the network device, the terminal device to report measurement activity information applied at the terminal device to the network device; and
wherein the measurement activity information indicating whether or not measurement relaxation in measurements on the network device is applied at the terminal device;
receive by the network device the measurement activity information from the terminal device.

63. The network device of claim 62, wherein the measurements on the network device comprise one or more of the following:
radio resource management measurements, or radio link monitoring measurements, or serving cell measurements, or non-serving cell measurements.

64. The network device of claim 62, wherein the measurement activity information is received via physical layer signaling or medium access control layer signaling or radio resource control layer signaling.

65. The network device of claim 64, wherein the radio resource control layer signaling comprises one or more of a measurement report, user equipment assistance information, or any other radio resource control message.

66. The network device of claim 62, wherein the measurement activity information comprises indication for one or more of the following:
radio resource management measurement relaxation level or radio link monitoring measurement level or low mobility condition information, or not-at-cell-edge condition information, or whether a threshold for controlling whether the terminal device is required to perform measurements on non-serving cells is fulfilled or not.

67. The network device of claim 66, wherein the radio resource management measurement relaxation level comprises indication of one or more of the following:
no radio resource management measurements, or relaxed radio resource management measurements, or regular radio resource management measurements, or relaxed radio link monitoring measurements, or regular radio link monitoring measurements.

68. The network device of claim 66, wherein the threshold comprises a threshold for one or more of the following:
cell quality or one or more sets of synchronization signal block-reference signal received power used to derive a cell quality level or one or more of channel state information-reference signal received power corresponding to cell-level reference signal received power based on one or more channel state information-reference signals measurement.

69. The network device of claim 62, wherein the network device comprises one of the following: a gNB; an eNB; a node forming part of the gNB; a node forming part of the eNB; a ng-eNB; multiple gNBs; multiple eNBs; a RRH or multiple RRHs; or a DU or multiple DUs.
